(19) United States
(12) Patent Application Publication
(10) Pub. No.: US 2012/0156532 A1
(43) Pub. Date: Jun. 21, 2012

(54) SECONDARY BATTERY

(75) Inventor: Seonghoon Han, Yongin-si (KR)

(73) Assignee: SAMSUNG SDI CO., LTD., Yongin-si (KR)

(21) Appl. No.: 13/306,036

(22) Filed: Nov. 29, 2011

(30) Foreign Application Priority Data
Dec. 15, 2010 (KR) 10-2010-0128341

(51) Int. Cl. H01M 2/02; H01M 2/12

(52) U.S. Cl. 429/53; 429/163

(57) ABSTRACT

A secondary battery includes an electrode assembly including a positive electrode plate and a negative electrode plate laminated with a separator and wound together, a positive electrode tab connected to the positive electrode plate and a negative electrode tab connected to the negative electrode plate, a case having an opening at an upper end to accommodate the electrode assembly and the case being made of a plastic material, and a cap assembly including a positive electrode lead tab electrically connected to the positive electrode tab and a negative electrode lead tab electrically connected to the negative electrode tab and the cap assembly being made of a plastic material to be coupled to the opening of the case.

### CLAIM OF PRIORITY

This application makes reference to, incorporates the same herein, and claims all benefits accruing under 35 U.S.C. §119 from an application earlier filed in the Korean Intellectual Property Office on Dec. 15, 2010 and there duly assigned Serial No. 10-2010-0128341.

### BACKGROUND OF THE INVENTION

1. Field of the Invention

One embodiment of the present invention relates to a secondary battery, and more particularly, to a secondary battery including a case having enhanced mechanical strength.

2. Description of the Related Art

A lithium secondary battery has a bare cell, which includes an electrode assembly with a positive electrode, a negative electrode, and a separator disposed between the positive and negative electrodes, and a case housing the electrode assembly and electrolyte.

The case of a bare cell may generally be made of an aluminum can or an aluminum composite case. The case made of the aluminum can may be improved in strength while being heavier. A case made of a pouch film may be lighter while having a reduced strength.

Accordingly, research on a case having enhanced strength and made of a lighter material is continuously being conducted.

### SUMMARY OF THE INVENTION

An aspect of the present invention provides a secondary battery including a to case having enhanced mechanical strength and made of a lighter material.

Another aspect of the present invention provides a secondary battery including a case having excellent chemical resistance.

In accordance with an aspect of the present invention, there is provided a secondary battery including an electrode assembly including a positive electrode plate and a negative electrode plate laminated with a separator and wound together, a positive electrode tab electrically connected to the positive electrode plate and a negative electrode tab electrically connected to the negative electrode plate, a case having an opening at an upper end to accommodate the electrode assembly and the case being made of a plastic material, and a cap assembly including a cap plate physically connected to a positive electrode lead tab electrically connected to the positive electrode tab and to a negative electrode lead tab electrically connected to the negative electrode tab and the cap plate being made of a plastic material to be coupled to the opening of the case.

Here, the case may be made of MC nylon or polyether ether ketone (PEEK). In addition, the cap plate and the case may be made of the same material.

The cap assembly may further include a safety vent formed at the cap plate. The safety vent may be formed between the positive electrode lead tab and the negative electrode lead tab in the cap plate. The safety vent may be thinner than other parts of the cap plate. The safety vent may be formed to have a groove shape. The safety vent may have grooves formed at corresponding locations of top and bottom surfaces of the cap plate.

In addition, the cap plate and the positive and negative electrode lead tabs may be formed by insertion molding. The positive electrode lead tab and the negative electrode lead tab may be respectively electrically coupled to the positive electrode tab and the negative electrode tab, by welding or bolt connection.

The electrode assembly may include a plurality of unit electrode assemblies.

As described above, in the secondary battery constructed as the embodiment of the present invention, since the case is made of a plastic material, the case has enhanced strength and is relatively light.

In addition, in the secondary battery constructed as the embodiment of the present invention, since the cap plate and the case are made of the same material, and the cap plate and the positive and negative electrode lead tabs may be integrally formed by insertion molding, the manufacturing process of the secondary battery may be simplified.

Further, in the secondary battery constructed as the embodiment of the present invention, since the case is made of a plastic material, chemical resistance of the case may be improved.

Additional aspects and/or advantages of the invention will be set forth in part in the description which follows and, in part, will be obvious from the description, or may be learned by practice of the invention.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

The objects, features and advantages of the present invention will be more apparent from the following detailed description in conjunction with the accompanying drawings, in which:

FIG. 1 is an exploded oblique view illustrating a secondary battery constructed with an embodiment of the present invention;

FIG. 2 is a cross-sectional view of the secondary battery shown in FIG. 1, taken along the line II-IF;

FIG. 3 is a cross-sectional view of the secondary battery shown in FIG. 1, taken along the line III-III′; and

FIG. 4 is an oblique view illustrating the secondary battery shown in FIG. 1.

### DETAILED DESCRIPTION OF THE INVENTION

Hereinafter, embodiments of the present invention will be described in detail with reference to the accompanying drawings such that they can easily be made and used by those skilled in the art.

First, a secondary battery according to an embodiment of the present invention will now be described.

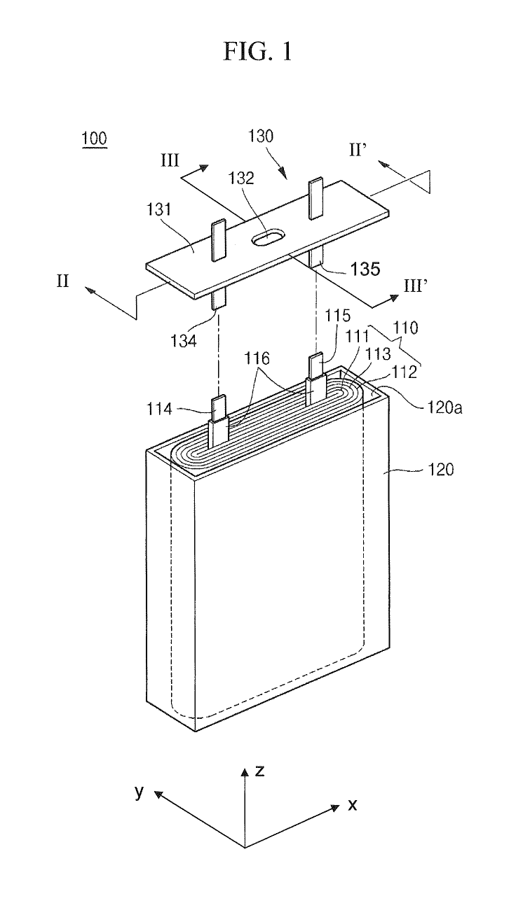

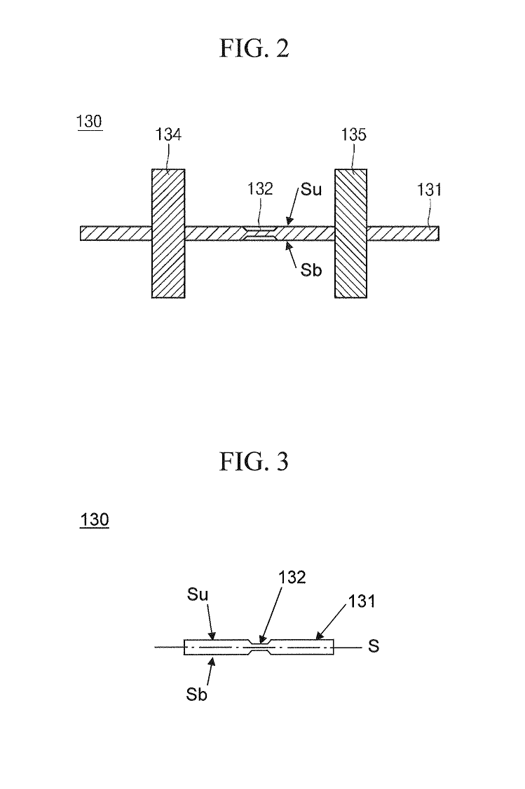

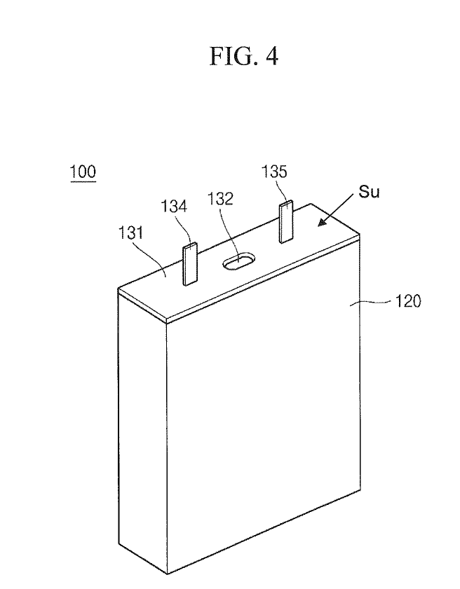

FIG. 1 is an exploded oblique view illustrating a secondary battery according to an embodiment of the present invention, FIG. 2 is a cross-sectional view of the secondary battery shown in FIG. 1, taken along the line FIG. 3 is a cross-sectional view of the secondary battery shown in FIG. 1, taken along the line and FIG. 4 is an oblique view illustrating the secondary battery shown in FIG. 1.

Referring to FIGS. 1 through 3, the secondary battery 100 according to the illustrated embodiment of the present invention includes an electrode assembly 110, a case 120, and a cap assembly 130.

The electrode assembly 110 may include plate-shaped positive and negative electrode plates 111 and 112, and a separator 113 interposed between the positive and negative electrode plates 111 and 112, and the electrode plates 111 and 112 and the separator 113 are wound in a jelly-roll configuration. The electrode assembly 110 includes a positive electrode tab 114 and a negative electrode tab 115.

The positive electrode plate 111 may include a positive electrode collector made of a metal film having excellent conductivity, for example, an aluminum foil, and a positive electrode active material coated on both surfaces of the positive electrode collector. Examples of the positive electrode active material may include lithium oxides, such as LiCoO₂, LiMn₂O₄, LiNiO₂, LiMnO₂, or the like. A positive electrode collector area in which a positive electrode active material layer is not formed, that is a positive electrode uncoated region, is formed at opposite ends of the positive electrode plate 111. The positive electrode tab 114 made of aluminum (Al) is formed at one end of the positive electrode uncoated region.

The negative electrode plate 112 includes a negative electrode collector formed of a conductive metal film, for example, a copper (Cu) foil, and a negative electrode active material layer coated on both surfaces of the negative electrode collector. A negative electrode collector area in which a negative electrode active material layer is not formed, that is a negative electrode uncoated region, is formed at opposite ends of the negative electrode plate 112. A negative electrode tab 115 made of nickel (Ni) is welded to one end of the negative electrode uncoated region.

The separator 113 is made of polyethylene (PE), polypropylene (PP), or a copolymer of PE and PP. The separator 113 prevents electronic conduction between the positive electrode plate 111 and the negative electrode plate 112 in the electrode assembly 110 while allowing migration of lithium ions in the electrode assembly 110. The separator 113 prevents the positive electrode plate 111 and the negative electrode plate 112 from contacting each other while preventing a temperature of the secondary battery 100 from increasing due to a shut-down when the temperature of the secondary battery 100 rises due to an external short circuit. In order to prevent short-circuiting between the positive electrode plate 111 and the negative electrode plate 112, a ceramic layer prepared by mixing a ceramic material with a binder may further be provided in addition to the separator 113. To prevent electrodes from being short-circuited, it is advantageous to form the separator 113 to be wider in the z-direction than the positive electrode plate 111 or the negative electrode plate 112.

The positive electrode tab 114 and the negative electrode tab 115 are respectively electrically connected to the positive electrode plate 111 and the negative electrode plate 112, in order to electrically connect the electrode assembly 110 to the cap assembly 130. An electrical insulation tape 116 for preventing the positive electrode tab 114 and the negative electrode tab 115 from being short-circuited is wound around an externally drawn boundary portion of the electrode assembly 110. The insulation tape 116 prevents the positive electrode tab 114 or the negative electrode tab 115 from being short-circuited due to a contact between the negative electrode plate 112 or the positive electrode plate 111 at an upper portion of the electrode assembly 110.

The case 120 may have a rectangular parallelpiped shape having a hollow internal space. In addition, the case 120 has long side surfaces having a relatively large area and short side surfaces having a relatively small area. The case 120 also has an opening 120a formed at its upper portion. The case 120 has the electrode assembly 110 housed therein. In addition, the case 120 accommodates an electrolyte injected thereto. The electrolyte allows migration of lithium ions generated by electrochemical reactions occurring inside the battery during charging and discharging. The electrolyte may be nonaqueous organic electrolyte that is a mixture of a lithium salt and a high-purity organic solvent. The electrolyte (not shown) may also be a polymer using a polymeric electrolyte.

In order to enhance the strength of the case 120 against external shocks, the case 120 may be made of a plastic material that is highly resistant to external shocks and is excellent in chemical resistance and light in weight. In particular, the case 120 may be made of at least one selected from MC nylon based resins and polyether ether ketone (PEEK) resins. Here, the MC nylon based resin is engineering plastic formed by chemical change at atmospheric pressure by injecting a nylon monomer mixed with a reaction catalyst into a mold. The polyether ether ketone (PEEK) resin is an extrusion-formed super-engineering plastic material that is used at a peak temperature of 250° C. and has excellent chemical resistance. The case 120 may be formed with a plastic resin that is robust against external shocks and lightweight. Accordingly, the case 120 may achieve a high strength, lightweight electrode assembly, compared to the conventional electrode assembly formed of an aluminum can or a pouch film.

Meanwhile, in order to increase thermal conductivity, the case 120 may be formed by coating a thermally conductive film on the surface of the plastic material, for example, a graphite film (not shown). The graphite film is capable of dissipating heat of the case 120 to the outside in a more efficient manner.

The opening 120a allows the electrode assembly 110 and the electrolyte to be inserted into the case 120. The opening 120a is formed on the entire top surface of the case 120. In addition, the opening 120a is sealed by a cap plate 131.

The cap assembly 130 includes a cap plate 131, a safety vent 132, a positive electrode lead tab 134, and a negative electrode lead tab 135. The cap assembly 130 is preferably formed by integrally forming the cap plate 131 and the positive and negative electrode lead tabs 134 and 135 through insertion molding. In the insert molding, a plastic part is formed or molded directly over or around metal or plastic components, resulting in a single piece assembly. That is to say, the cap assembly 130 is formed by a simplified process.

The cap assembly 130 is coupled to the opening 120a of the case 120 to seal the case 120.

The cap plate 131 is plate-shaped and is formed to have the corresponding size and shape to those of the opening 120a of the case 120. The cap plate 131 is made of an electrically insulating plastic material, preferably the same material as the case 120. The cap plate 131 is coupled to the opening 120a of the case 120 by welding. In addition, when the cap plate 131 and the case 120 are made of the same material, the welding is performed more efficiently.

As shown in FIGS. 2 and 3, the safety vent 132 may be formed at a predetermined location of the center of the cap plate 131; preferably between the positive electrode lead tab 134 and the negative electrode lead tab 135. The positive electrode lead tab 134 and the negative electrode lead tab 135 may be strip or plate made of solid conductive material. The safety vent 132 may be thinner than other parts of the cap plate 131. The safety vent 132 may be preferably formed in the shape of a groove formed at corresponding locations of top and bottom surfaces Su and Sb of the cap plate 131. In one embodiment, as shown in FIG. 3, the safety vent may have two opposite grooves which are disposed in a mirror symmetry with respect to a symmetrical line S of the cap plate 131. In addition, the safety vent 132 may have a planar portion having an elliptical shape, a circular shape, or a rectangular shape. When the internal pressure of battery increases to a predetermined level, the safety vent 132 is ruptured to release the internal gas to the outside, thereby preventing fire or explosion of battery.

The positive electrode lead tab 134 and the negative electrode lead tab 135 may be formed to extend across the cap plate 131 from the top surface to the bottom surface of the cap plate 131. Preferably, the positive electrode lead tab 134 and the negative electrode lead tab 135 are integrally formed with the cap plate 131 by insertion molding. Since the cap plate 131 is made of a plastic material that is an electrical insulator, the positive electrode lead tab 134 and the negative electrode lead tab 135 are electrically insulated from each other by the cap plate 131.

The positive electrode lead tab 134 is electrically connected to the positive electrode tab 114, and the negative electrode lead tab 135 is electrically connected to the negative electrode tab 115. In addition, when the electrode assembly 110 is housed in the case 120, the positive electrode lead tab 134 is formed at a location of the cap plate 131 corresponding to the positive electrode tab 114. Accordingly, the positive electrode lead tab 134 may be easily connected to the positive electrode tab 114. Likewise, the negative electrode lead tab 135 may be formed at a location of the cap plate 131 corresponding to the negative electrode tab 115.

The positive electrode lead tab 134 and the negative electrode lead tab 135 may be respectively electrically coupled to the positive electrode tab 114 and the negative electrode tab 115, by welding or bolt connection. The welding may be performed by resistance welding, laser welding or ultrasonic welding.

While the illustrated embodiment shows that a secondary battery in which one electrode assembly is accommodated in the case, a plurality of electrode assemblies may also be accommodated in the case. Although not shown, the secondary battery has a plurality of electrode assemblies accommodated in a case. Alternatively, a plurality of positive electrode tabs and negative electrode tabs drawn out from the plurality of electrode assemblies may be electrically connected to one positive electrode lead tab and one negative electrode lead tab formed in a cap assembly. In addition, in the secondary battery according to the present invention, when multiple electrode assemblies are provided, a plurality of positive and negative electrode lead tabs may also be provided in the cap assembly. In such a case, the positive electrode tab and the negative electrode tab may be electrically connected to a relatively close positive and negative electrode lead tabs.

Although a few embodiments of the present invention have been shown and described, it would be appreciated by those skilled in the art that changes may be made in these embodiments without departing from the scope of the invention as defined in the appended claims.

What is claimed is:

1. A secondary battery, comprising:
an electrode assembly comprising a positive electrode plate and a negative electrode plate laminated with a separator, a positive electrode tab connected to the positive electrode plate and a negative electrode tab connected to the negative electrode plate;
a case comprising an opening at an upper end, the case accommodating the electrode assembly, and the case being made of a plastic material; and
a cap assembly comprising a cap plate connected to a positive electrode lead tab connected to the positive electrode tab and to a negative electrode lead tab connected to the negative electrode tab, and the cap plate being made of a plastic material and being coupled to the opening of the case.

2. The secondary battery of claim 1, wherein the case is made of from a material selected from among MC nylon and polyether ether ketone (PEEK).

3. The secondary battery of claim 1, wherein the cap plate and the case are made of the same material.

4. The secondary battery of claim 1, wherein the cap assembly further includes a safety vent formed at the cap plate.

5. The secondary battery of claim 4, wherein the safety vent is formed between the positive electrode lead tab and the negative electrode lead tab in the cap plate.

6. The secondary battery of claim 5, wherein the safety vent is thinner than other parts of the cap plate.

7. The secondary battery of claim 5, wherein the safety vent is formed to have a groove shape.

8. The secondary battery of claim 7, wherein the safety vent comprises grooves formed at corresponding locations of top and bottom surfaces of the cap plate.

9. The secondary battery of claim 1, wherein the cap plate and the positive and negative electrode lead tabs are formed by insertion molding by forming the positive and negative electrode lead tabs directly adjacent to the cap plate, and the positive and negative electrode lead tabs and the cap plate form a single body.

10. The secondary battery of claim 1, wherein the positive electrode lead tab and the negative electrode lead tab are respectively coupled to the positive electrode tab and the negative electrode tab by welding or bolt connection.

11. The secondary battery of claim 1, wherein the electrode assembly includes a plurality of unit electrode assemblies.

12. A secondary battery, comprising:
an electrode assembly comprising a positive electrode plate and a negative electrode plate with a separator being interposed therebetween, a positive electrode tab connected to the positive electrode plate, and a negative electrode tab connected to the negative electrode plate;
a case comprising an opening accommodating installation of the electrode assembly;
a cap assembly being coupled to the opening of the case, the cap assembly comprising a cap plate connected to a positive electrode lead tab connected to the positive to electrode tab and to a negative electrode lead tab connected to the negative electrode tab; and
the cap plate and the case being made of the same insulating plastic material.

13. The secondary battery of claim 12, wherein the positive and negative electrode lead tabs are formed directly adjacent to the cap plate by a process of insertion molding, and the positive and negative electrode lead tabs and the cap plate form a single body.

14. The secondary battery of claim 12, wherein the cap assembly and the case are made of one of MC nylon and polyether ether ketone (PEEK).
